(19) United States
(12) Patent Application Publication
(10) Pub. No.: US 2023/0339172 A1
(43) Pub. Date: Oct. 26, 2023

(54) NOVEL RESIN SUITABLE FOR STEREOLITHOGRAPHIC PRINTING USING POLY(1,1-DIFLUOROETHYLENE)

(71) Applicant: Intellectual Polymer Design, LLC, Centerville, UT (US)

(72) Inventors: Howard P. Fisher, Centerville, UT (US); Talon M. Kosak, Byron Center, MI (US)

(21) Appl. No.: 18/058,317

(22) Filed: Nov. 23, 2022

Related U.S. Application Data
(60) Provisional application No. 63/334,881, filed on Apr. 26, 2022.

(51) Int. Cl. B29C 64/124; B33Y 10/00; B33Y 70/00

(52) U.S. Cl. CPC B29C 64/124; B33Y 10/00; B33Y 70/00; B29K 2027/12

(57) ABSTRACT

A photocurable resin composition is provided that is suitable for use in stereolithography, comprising from about 2 weight percent to about 75 weight percent of a fluoropolymer, particularly poly(1,1-difluoroethylene), or an aromatic engineering thermoplastic polymer, a sulfur-based engineering thermoplastic polymer, a fluorine-based engineering thermoplastic polymer, or a commodity thermoplastic polymer. Also provided is a process for making three dimensional objects from successive layers of the photocurable resin composition described herein.

### CROSS-REFERENCE TO RELATED APPLICATIONS

The present invention is a U.S. Utility patent application that claims priority to U.S. Provisional Patent Application No. 63/334,881, filed on Apr. 26, 2022, the entire disclosure of which is incorporated herein by reference.

### TECHNICAL FIELD

The present invention relates to a novel resin for stereolithographic printing comprising from about 2 weight percent to about 75 percent weight percent of a fluoropolymer, particularly poly(1,1-difluoroethylene), and related processes for making three dimensional objects therefrom.

### BACKGROUND

A group of additive manufacturing techniques sometimes referred to as “stereolithography” (SLA) create a three-dimensional object by the sequential polymerization of a light polymerizable resin. Such techniques may be “bottom-up” techniques, where light is projected into the resin onto the bottom of the growing object through a light transmissive window, or “top down” techniques, where light is projected onto the resin on top of the growing object, which is then immersed downward into the pool of resin.

Fluoropolymers are a commercially important class of materials most notable for their “non-stick” and friction reducing properties. In general, a fluoropolymer is a fluorocarbon-based polymer having multiple carbon-fluorine bonds and shares similar properties as fluorocarbons as not being susceptible to van der Waals forces. These properties of being non-stick and friction reducing contribute to fluoropolymers being resistant to solvents, acids, and bases. Moreover, fluoropolymers display excellent resistance toward corrosive chemicals, have excellent mechanical properties, good high temperature performance, and outstanding dielectric strength.

However, forming a three-dimensional (3D) object of fluoropolymer material is a challenge. There are traditional approaches such as injection molding and blow molding, but the required equipment and molds are expensive, and the design becomes locked to the mold and cannot be changed without retooling. There is also an additive manufacturing technique called fused deposition modeling (FDM) in which a fluoropolymer filament is melted in a small extruder and a part is created layer by layer. Although the FDM process works, the layer lines are very coarse which results in unappealing surfaces.

Accordingly, there is a need for a novel resin for stereolithographic printing comprising fluoropolymer material.

### SUMMARY

To address the foregoing problems, in whole or in part, and/or other problems that may have been observed by persons skilled in the art, the present disclosure provides compositions and methods as described by way of example as set forth below.

The present invention is directed to a photocurable resin composition suitable for use in stereolithography comprising from about 2 weight percent to about 75 percent weight percent of a fluoropolymer, particularly at least 50 weight percent of a fluoropolymer. In some embodiments, the fluoropolymer is polyvinylidene fluoride, polyvinylidene difluoride (PVDF), polychlorotrifluoroethylene, poly(1,1-difluoroethylene), or a homopolymer, copolymer, or terpolymer thereof. In other embodiments, the fluoropolymer is poly(1,1-difluoroethylene) or a homopolymer, copolymer, or terpolymer thereof. In other embodiments, the fluoropolymer comprises poly(1,1-difluoroethylene) copolymers comprising a range between 20%-60% 1,2,3,3,3-hexafluoroprop-1-ene and characterized by a glass transition temperature range of −50 C to −30 C.

In another embodiment, a photocurable resin composition suitable for use in stereolithography is provided, comprising from about 2 weight percent to about 75 percent weight percent of a polymer, wherein the polymer is an aromatic engineering thermoplastic polymer, a sulfur-based engineering thermoplastic polymer, a fluorine-based engineering thermoplastic polymer, or a commodity thermoplastic polymer. In some embodiments, the aromatic engineering thermoplastic polymer comprises polyether ether ketone (PEEK), polyetherketoneketone (PEKK), or polyetherketone (PEK). In some embodiments, the sulfur-based engineering thermoplastic polymer comprises polyphenylene sulfide (PPS), polysulfone (PSU), polyethersulfone (PES), or polyphenylsulfone (PPSU). In some embodiments, the fluorine-based engineering thermoplastic polymer comprises polyvinylidene fluoride, polyvinylidene difluoride (PVDF), ethylene chlorotrifluoroethylene (ECTFE), ethylene tetrafluoroethylene (ETFE), fluorinated ethylene propylene (FEP), perfluoroalkoxy alkanes (PFA), or polytetrafluoroethylene (PTFE). In some embodiments, the commodity thermoplastic polymer comprises polypropylene (PP), polyethene (PE), polyvinyl chloride (PVC), poly(methyl methacrylate) (PMMA), acrylonitrile butadiene styrene (ABS), polylactic acid (PLA), or polyamide (PA).

In still further embodiments, the photocurable resin further comprises one or more multifunctional monomers, photoinitiators, reactive diluents, or ultraviolet (UV) blockers.

The present invention is also directed to a process for making three dimensional objects from successive layers of a photocurable resin composition comprising the steps of:
(a) forming a layer of the photocurable resin composition;
(b) curing at least a portion of the layer by exposure to radiation;
(c) introducing a new layer of resin composition onto the layer previously exposed to the radiation; and
(d) repeating steps (b) and (c) until a three-dimensional object is formed;
   wherein the photocurable resin composition comprises any of the photocurable resin compositions described herein.

Additional features of the invention will be or will become apparent to one with skill in the art upon examination of the following figures and detailed description. It is intended that all such additional features and advantages be included within this description, be within the scope of the invention and be protected by the accompanying claims.

### DETAILED DESCRIPTION

The subject matter of the present invention now will be described more fully hereinafter, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions. Therefore, it is to be understood that the subject matter of the present invention is not to be limited to the specific embodiments disclosed and that modifications and other embodiments are intended to be included within the scope of the appended claims.

### Novel Resin Suitable for Stereolithographic Printing Using Poly(1,1-Difluoroethylene)

The present invention is directed to the first known instance of a liquid resin with a high (>50 weight percent) amount of poly(1,1-difluoroethylene) that can be solidified by crosslink formation when exposed to ultraviolet light, forming a useful final polymer. This resin would find suitable applications in many areas and is not limited to additive manufacturing methods found in stereolithography printing, lithography methods used in creating photomasks for semiconductor manufacturing, adhesive systems, field applied corrosion-resistant coatings, thin-film coatings used for protection of interior and exterior stone surfaces, as a means to improve aggregate retention on weathered composite shingles used in roofing applications and for use in functional and decorative architectural metal coatings.

As described in the Background section, forming a three-dimensional (3D) object of fluoropolymer material is a challenge. Traditional approaches such as injection molding and blow molding require expensive equipment and molds, and the design becomes locked to the mold and cannot be changed without retooling. FDM methods in which a fluoropolymer filament is melted in a small extruder and a part is created layer by layer produce layer lines that are very coarse, resulting in unappealing surfaces. In contrast, the present invention uses a stereolithography (SLA) method in which the layer lines are almost undetectable, resulting in finished parts that are much more pleasing than with FDM methods and comparable to injection molding. Prior to the present invention, SLA printing methods were limited to a very narrow selection of unique resins. Although there are many resins on the market, most of these resins are designed for the consumer market and there is a lot of redundancy. The fluoropolymer-based resin of the present invention is designed for chemists and engineers. The resin is tough and has high strength with a high PVDF content, it offers all the advantages of a fluoropolymer, as you have indicated.

Accordingly, the present invention relates to a crosslinked resin that combines high amounts of a fluoropolymer such as poly(1,1-difluoroethylene) to produce a final material that is hard, tough and retains dimensional stability. The uncrosslinked resin is safe to handle, nonflammable and exhibits long-term shelf life without gel formation while keeping all of the material components remain in solution.

In one embodiment, the present invention is directed to a photocurable resin composition suitable for use in stereolithography comprising from about 2 weight percent to about 75 percent weight percent of a fluoropolymer, particularly at least 50 weight percent of a fluoropolymer. In some embodiments, the fluoropolymer is polyvinylidene fluoride, polyvinylidene difluoride (PVDF), polychlorotrifluoroethylene, poly(1,1-difluoroethylene), or a homopolymer, copolymer, or terpolymer thereof. In other embodiments, the fluoropolymer is poly(1,1-difluoroethylene) or a homopolymer, copolymer, or terpolymer thereof. In other embodiments, the fluoropolymer comprises poly(1,1-difluoroethylene) copolymer comprising a range between 20%-60% 1,2,3,3,3-hexafluoroprop-1-ene and characterized by a glass transition temperature range of −50 C to −30 C.

In another embodiment, a photocurable resin composition suitable for use in stereolithography is provided, comprising from about 2 weight percent to about 75 percent weight percent of a polymer, wherein the polymer is an aromatic engineering thermoplastic polymer, a sulfur-based engineering thermoplastic polymer, a fluorine-based engineering thermoplastic polymer, or a commodity thermoplastic polymer. In some embodiments, the aromatic engineering thermoplastic polymer comprises polyether ether ketone (PEEK), polyetherketoneketone (PEKK), or polyetherketone (PEK). In some embodiments, the sulfur-based engineering thermoplastic polymer comprises polyphenylene sulfide (PPS), polysulfone (PSU), polyethersulfone (PES), or polyphenylsulfone (PPSU). In some embodiments, the fluorine-based engineering thermoplastic polymer comprises polyvinylidene fluoride, polyvinylidene difluoride (PVDF), ethylene chlorotrifluoroethylene (ECTFE), ethylene tetrafluoroethylene (ETFE), fluorinated ethylene propylene (FEP), perfluoroalkoxy alkanes (PFA), or polytetrafluoroethylene (PTFE). In some embodiments, the commodity thermoplastic polymer comprises polypropylene (PP), polyethene (PE), polyvinyl chloride (PVC), poly(methyl methacrylate) (PMMA), acrylonitrile butadiene styrene (ABS), polylactic acid (PLA), or polyamide (PA).

The photocurable resin composition of the present invention can have additional ingredients solubilized therein, including pigments, dyes, diluents, active compounds or pharmaceutical compounds, detectable compounds (e.g., fluorescent, phosphorescent, radioactive), and the like, depending upon the particular purpose of the product being fabricated.

Examples of such additional ingredients include, but are not limited to, proteins, peptides, nucleic acids (DNA, RNA) such as siRNA, sugars, small organic compounds (drugs and drug-like compounds), etc., including combinations thereof. In particular embodiments, the photocurable resin further comprises one or more multifunctional monomers, photoinitiators, reactive diluents, or ultraviolet (UV) blockers.

Conventional additive manufacturing techniques (often referred to as “3D printing”), involves construction of a three-dimensional object is performed in a step-wise or layer-by-layer manner by sequentially exposing a light-polymerizable resin to patterned light. Generally referred to as “stereolithography,” numerous examples are known, including those described in U.S. Pat. No. 5,236,637 to Hull (see, e.g., FIGS. 3-4) and U.S. Pat. No. 7,892,474 to Shkolnik. Additional examples are given in U.S. Pat. Nos. 5,391,072 and 5,529,473 to Lawton, U.S. Pat. No. 7,438,846 to John, U.S. Pat. No. 8,110,135 to El-Siblani, and US Patent Application Publication Nos. 2013/0292862 to Joyce and 2013/0295212 to Chen et al.

Accordingly, in other embodiments, the present invention is also directed to a process for making three dimensional objects from successive layers of a photocurable resin composition comprising the steps of:
(a) forming a layer of the photocurable resin composition;
(b) curing at least a portion of the layer by exposure to radiation;
(c) introducing a new layer of resin composition onto the layer previously exposed to the radiation; and
(d) repeating steps (b) and (c) until a three-dimensional object is formed;
   wherein the photocurable resin composition comprises any of the photocurable resin compositions described herein.

The term “fluoropolymer” means a polymer formed by the polymerization of at least one fluoromonomer, and it is inclusive of homopolymers, copolymers, terpolymers and higher polymers which are thermoplastic in their nature, meaning they are capable of being formed into useful pieces by flowing upon the application of heat, such as is done in molding and extrusion processes. The thermoplastic polymers typically exhibit a crystalline melting point. Especially preferred fluoropolymers for stereolithography printing application include polymers and copolymers of polyvinylidene fluoride or polychlorotrifluoroethylene.

Poly(1,1-difluoroethylene) as used herein includes both normally solid, high molecular weight homopolymers, copolymers and terpolymers. Such copolymers and terpolymers include those containing at least 50 mole percent of vinylidene fluoride copolymerized with at least one comonomer selected from the group consisting of tetrafluoroethylene, trifluoroethylene, chlorotrifluoroethylene, hexafluoropropene, vinyl fluoride, pentafluoropropene, perfluoromethyl vinyl ether, perfluoropropyl vinyl ether and any other monomer that would readily copolymerize with vinylidene fluoride. Particularly preferred are copolymers composed of from at least about 70 and up to 99 mole percent vinylidene fluoride, and correspondingly from 1 to 30 percent tetrafluoroethylene; and about 70 to 99 percent vinylidene fluoride and 1 to 30 percent hexafluoropropene (as described in U.S. Pat. No. 3,178,399); and about 70 to 99 mole percent vinylidene fluoride and 1 to 30 mole percent trifluoroethylene. Terpolymers of vinylidene fluoride, hexafluoropropene and tetrafluoroethylene such as described in U.S. Pat. No. 2,968,649 and terpolymers of vinylidene fluoride, trifluoroethylene and tetrafluoroethylene are also representatives of the class of vinylidene fluoride copolymers which can be used in the process embodied herein.

Poly(1,1-difluoroethylene) can be dissolved by a number of solvents. Initial experimental attempts were made to combine a liquid solution of poly(1,1-difluoroethylene) with different light-reactive thermoset resins. These resin systems consisted of multifunctional monomers, photoinitiators, reactive diluents and UV blockers combined with the poly(1,1-difluoroethylene) solution.

Methods for working with UV-sensitive and hydrophilic materials as well as good laboratory practices are well known in the art.

### General Definitions

Although specific terms are employed herein, they are used in a generic and descriptive sense only and not for purposes of limitation. Unless otherwise defined, all technical and scientific terms used herein have the same meaning as commonly understood by one of ordinary skill in the art to which this presently described subject matter belongs.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter. The descriptions and specific examples that follow are only intended for the purposes of illustration and are not to be construed as limiting the compositions and methods of the disclosure.

### Example 1

Experiment 1 consisted of 7.81 grams of the final resin made from 3.3 weight percent poly(1,1-difluoroethylene) dissolved in 33.33 weight percent n,n-dimethylformamide and combined with 63.38 weight percent of a crosslinking resin. The crosslinking resin was a 100 gram solution consisting of 39.776 grams of Allnex Ebecryl 8210, 39.776 grams of poly(oxy-1,2-ethanediyl), α-hydro-ω-[(1-oxo-2-propen-1-yl)oxy]-, ether with 2,2-bis(hydroxymethyl)-1,3-propanediol (4:1), 0.4 grams of diphenylphosphoryl-(2,4,6-trimethylphenyl)methanone, 19.888 grams of 2-(butylcarbamoyloxy)ethyl prop-2-enoate, and 0.16 grams of 5-tert-butyl-2-[5-(5-tert-butyl-1,3-benzoxazol-2-yl)thiophen-2-yl]-1,3-benzoxazole. The final resin combination began to gel after 16 hours and was not suitable in a stereolithographic printer.

### Example 2

Experiment 2 consisted of 10.95 grams of the final resin made from 9.13 weight percent poly(1,1-difluoroethylene) dissolved in 45.66 weight percent n,n-dimethylformamide combined with 45.21 weight percent of the crosslinking resin used in Experiment 1. The final resin began to gel after 120 hours and was not suitable in a stereolithographic printer.

### Example 3

Experiment 3 consisted of 9.95 grams of the final resin made from 10.05 weight percent poly(1,1-difluoroethylene) dissolved in 40.20 weight percent n,n-dimethylformamide combined with 49.75 weight percent of the crosslinking resin used in Experiment 1. The final resin began to gel after 24 hours and was not suitable in a stereolithographic printer.

### Example 4

Experiment 4 consisted of 8.45 grams of the final resin made from 11.83 weight percent poly(1,1-difluoroethylene) dissolved in 29.59 weight percent n,n-dimethylformamide combined with 58.58 weight percent of the crosslinking resin used in Experiment 1. The final resin began to gel immediately upon cooling to room temperature and was not suitable in a stereolithographic printer.

### Example 5

Experiment 5 consisted of 100 grams of the final resin made from 9.13 weight percent poly(1,1-difluoroethylene) dissolved in 45.66 weight percent n,n-dimethylformamide with 45.21 weight percent of the crosslinking resin used in Experiment 1. This resin was used in an SLA printer and produced the first result containing PVDF. The solution gelled in the vat as the solution temperature cooled. The resin was printed in a stereolithographic printer but the resulting part was extremely brittle.

### Example 6

Experiment 6 consisted of 52.7 grams of the final resin made from 8.54 weight percent poly(1,1-difluoroethylene) combined with 2.13 weight percent poly(methyl 2-methylpropenoate) dissolved in 42.1 weight percent n,n-dimethylformamide and 5.12 weight percent oxolane combined with 42.1 weight percent of the resin used in Experiment 1. This resin was used in a stereolithographic printer and the resulting parts had improved strength compared with the Experiment 5 results but lost dimensional stability over a 24-hour time period.

### Example 7

Experiment 7 consisted of 102.8 grams of the final resin made from 15.00 weight percent poly(1,1-difluoroethylene) combined with 5.00 weight percent poly(methyl 2-methylpropenoate) dissolved in 37.5 weight percent n,n-dimethylformamide and 5.00 weight percent oxolane combined with 37.5 weight percent of the resin used in Experiment 1. Upon cooling, attempts to print parts with a stereolithographic printer were halted due to gel formation. These partial prints made were noticeably brittle.

### Example 8

Experiment 8 consisted of 106 grams of the final resin made from 14.15 weight percent poly(1,1-difluoroethylene) combined with 2.83 weight percent poly(methyl 2-methylpropenoate) dissolved in 39.15 weight percent n,n-dimethylformamide and 4.72 weight percent oxolane. This solution was combined with 39.15 weight percent of the resin used in Experiment 1. This resin was used in a stereolithographic printer and resulted in parts with improved strength compared to the results of Experiment 5 and Experiment 7. This was the highest percentage of poly(1,1-difluoroethylene) obtained using the combined n,n-dimethylformamide and oxolane solvent system.

### Example 9

Experiment 9 consisted of 92.5 grams of the final resin made from 16.22 weight percent poly(1,1-difluoroethylene) combined with 5.41% poly(methyl 2-methylpropenoate) dissolved in 13.51 weight percent n,n-dimethylformamide and 21.62% trimethyl phosphate. This solution was combined with 43.24 weight percent of the resin used in Experiment 1. The use of trimethyl phosphate as a cosolvent with n,n-dimethylformamide resulted in marked improvements over previous formulations when used in stereolithographic printing applications. However, the volatility of the solvent system caused the printed part to lose dimensional stability over time in a similar fashion to the results of Experiment 6.

The application of a more complex and environmentally friendly solvent system was found to be advantageous. Of the available solvents, diluents and latent solvents employed for usage with poly(1,1-difluoroethylene), 2,3-diacetyloxypropyl acetate, triethyl phosphate, (methanesulfinyl)methane, 1,3-Dioxolan-2-one, 4-methyl-1,3-dioxolan-2-one, were deemed to also be suitable for experimentation. These solvents were chosen based on their low relative toxicity, high boiling points, and ability to solvate poly(1,1-difluoroethylene).

### Example 10

Experiment 10 consisted of 108.61 grams of the final resin made from 14.07 weight percent poly(1,1-difluoroethylene) combined with 4.60 weight percent poly(methyl 2-methylpropenoate) dissolved in 6.91 weight percent n,n-dimethylformamide and 23.78 weight percent triethyl phosphate. This solution was combined with 43.24 weight percent of the resin used in Experiment 1. The combination of triethyl phosphate as the primary cosolvent with n,n-dimethylformamide resulted in a reduction of volatility and improved strength of stereolithographic printed components. Reduction in weight loss and improved dimensional stability of the printed components were also observed. The reduction of volatile and toxic solvents, such as n,n-dimethylformamide, from use in this formulation, also resulted in an increased lifespan of the resin and improved health and safety considerations for end-users.

High poly(1,1-difluoroethylene) content (>50 weight percent) resins capable of crosslinking were obtained using solvents to make low viscosity resins. Specifically, poly(1,1-difluoroethylene) copolymer comprising a range between 20%-60% 1,2,3,3,3-hexafluoroprop-1-ene and characterized by a glass transition temperature range of −50 C to −30 C were found to be particularly compatible when combined with the resin used in Experiment 1.

### Example 11

Experiment 11 consisted of 150.001 grams of the final resin made from 50 weight percent poly(1,1-difluoroethylene) combined with 49.99 weight percent a modified crosslinking resin, and 0.000667-0.0013 weight percent of dispersing agent (BYK-W 980). The modified crosslinking resin was a 250 gram solution consisting of 125.00 grams of poly(oxy-1,2-ethanediyl), α-hydro-ω-[(1-oxo-2-propen-1-yl)oxy], ether with 2,2-bis(hydroxymethyl)-1,3-propanediol (4:1), 1.00 gram of diphenylphosphoryl(2,4,6-trimethylphenyl)methanone, 100.00 grams of 2-(butylcarbamoyloxy)ethyl prop-2-enoate, 0.40 grams of 5-tert-butyl-2-[5-(5-tert-butyl-1,3-benzoxazol-2-yl)thiophen-2-yl]1,3-benzoxazole, 11.80 grams of 6(2-methylprop-2-enoyloxy)hexyl 2-methylprop-2-enoate, and 11.80 grams of 2-[[3,5,5-trimethyl-6-[2-(2-methylprop-2-enoyloxy)ethoxycarbonylamino]hexyl]carbamoyloxy]ethyl 2-methylprop-2-enoate.

The resulting resin was found to be highly compatible with stereolithography printing at 20-25° C. The resin exhibited no volatility issues and the printed parts were found to maintain dimensional stability with desirable mechanical properties making this formulation with high content poly(1,1-difluoroethylene) resin suitable for stereolithography additive manufacturing.

Although the foregoing subject matter has been described in some detail by way of illustration and example for purposes of clarity of understanding, it will be understood by those skilled in the art that certain changes and modifications can be practiced within the scope of the appended claims.

1. A photocurable resin composition suitable for use in stereolithography comprising from about 2 weight percent to about 75 percent weight percent of a fluoropolymer.

2. The photocurable resin composition of claim 1, comprising at least 50 weight percent of a fluoropolymer.

3. The photocurable resin of claim 1, wherein the fluoropolymer is polyvinylidene fluoride, polyvinylidene difluoride (PVDF), polychlorotrifluoroethylene, poly(1,1-difluoroethylene), or a homopolymer, copolymer, or terpolymer thereof.

4. The photocurable resin of claim 3, wherein the fluoropolymer is poly(1,1-difluoroethylene) or a homopolymer, copolymer, or terpolymer thereof.

5. The photocurable resin of claim 4, further wherein the fluoropolymer comprises poly(1,1-difluoroethylene) copolymer comprises a range between 20%-60% 1,2,3,3,3-hexafluoroprop-1-ene and characterized by a glass transition temperature range of −50 C to −30 C.

6. The photocurable resin of claim 5, further comprising one or more multifunctional monomers, photoinitiators, reactive diluents, or ultraviolet (UV) blockers.

7. A process for making three dimensional objects from successive layers of a photocurable resin composition comprising the steps of:
(a) forming a layer of the photocurable resin composition;
(b) curing at least a portion of the layer by exposure to radiation;
(c) introducing a new layer of resin composition onto the layer previously exposed to the radiation; and
(d) repeating steps (b) and (c) until a three-dimensional object is formed;
wherein the photocurable resin composition comprises the photocurable resin of claim 1.

8. A photocurable resin composition suitable for use in stereolithography comprising from about 2 weight percent to about 75 percent weight percent of a polymer, wherein the polymer is an aromatic engineering thermoplastic polymer, a sulfur-based engineering thermoplastic polymer, a fluorine-based engineering thermoplastic polymer, or a commodity thermoplastic polymer.

9. The photocurable resin composition of claim 8, wherein the aromatic engineering thermoplastic polymer comprises polyether ether ketone (PEEK), polyetherketoneketone (PEKK), or polyetherketone (PEK).

10. The photocurable resin composition of claim 9, wherein the sulfur-based engineering thermoplastic polymer comprises polyphenylene sulfide (PPS), polysulfone (PSU), polyethersulfone (PES), or polyphenylsulfone (PPSU).

11. The photocurable resin composition of claim 9, wherein the fluorine-based engineering thermoplastic polymer comprises polyvinylidene fluoride, polyvinylidene difluoride (PVDF), ethylene chlorotrifluoroethylene (ECTFE), ethylene tetrafluoroethylene (ETFE), fluorinated ethylene propylene (FEP), perfluoroalkoxy alkanes (PFA), or polytetrafluoroethylene (PTFE).

12. The photocurable resin composition of claim 9, wherein the commodity thermoplastic polymer comprises polypropylene (PP), polyethene (PE), polyvinyl chloride (PVC), poly(methyl methacrylate) (PMMA), acrylonitrile butadiene styrene (ABS), polylactic acid (PLA), or polyamide (PA).

13. The photocurable resin of claim 9, further comprising one or more multifunctional monomers, photoinitiators, reactive diluents, or ultraviolet (UV) blockers.

14. A process for making three dimensional objects from successive layers of a photocurable resin composition comprising the steps of:
(a) forming a layer of the photocurable resin composition;
(b) curing at least a portion of the layer by exposure to radiation;
(c) introducing a new layer of resin composition onto the layer previously exposed to the radiation; and
(d) repeating steps (b) and (c) until a three-dimensional object is formed;
wherein the photocurable resin composition comprises the photocurable resin of claim 9.
